(19) United States
(12) Patent Application Publication
(10) Pub. No.: US 2016/0063983 A1
(43) Pub. Date: Mar. 3, 2016

(54) Novel Electronic Tablet Sound Amplifying Device

(71) Applicant: Leon Gellineau, Huntingon Station, NY (US)

(72) Inventor: Leon Gellineau, Huntingon Station, NY (US)

(73) Assignee: Leon Sydnee Gellineau, Huntington Station, CA (US)

(21) Appl. No.: 14/476,701

(22) Filed: Sep. 3, 2014

(51) Int. Cl. G10K 11/00

(52) U.S. Cl. CPC G10K 11/00

(57) ABSTRACT

A deployable curved plane is deployed below the speaker outlet of an electronic tablet. The curve conforms to the tablet when not deployed, and projects sound towards the user when deployed. When the amplifying curve is not deployed, it retracts and conforms to the tablet shape.

### FIELD OF THE INVENTION

The field of the invention is personal electronic device accessories.

### BACKGROUND OF THE INVENTION

The personal computer has evolved from desktop, to laptop, and now to tablet configurations. Single plane personal computer devices, or “tablets” as they are referred to can serve as data storage, internet device, camera, telephone, as well as touch screen keyboard and word and spreadsheet.

Specialty applications make these tablet computers more versatile and niche adapted. Since these devices are lightweight, and easily handled, they are ideal for presentations, videos, and business applications.

Because of their small size, having maximum use of their sound amplifiers makes their use easier when speaker use is needed.

Sound decreases exponentially in intensity as the distance for the source, so devices which concentrate and vector the sound towards the listener, have been in the public domaine since the gramophone and have their origin in horn instruments such as rams horns, which later evolved into the megaphone and other sound vectoring devices.

The necessity for compact geometry makes tablets unique in that accessories must not make the advantages for being planar and easy to carry disappear. The speakers on the tablet device are often on the edge where the sound travels laterally and away from the listener, as well as toward the listener. This means that a significant part of the sound energy is not received by the listener.

### OBJECTS OF THE INVENTION

One object of the invention is to develop a new sound directing system for tablet electronic devices. Yet another object of the invention is to develop an electronic device accessory. Yet another object of the invention is to develop a sound enhancing accessory for and electronic tablet computer.

Another object of the invention is to develop a retractible electronic accessory which is attached to the back of the tablet and serves as incline support for the screen. Yet another object of the invention is to develop a retractible speaker sound vectoring surface which increases volume perception by the listener.

### SUMMARY OF THE INVENTION

The invention is a thin plane which is curved at the end to conform to an electronic tablet surface. The outer section of the plane is attached to a grooved track which holds a retractible center sliding piece attached to the curve in “T” fashion with the head of the “T” being the curved outer portion.

If the head is deployed and extended, then it creates a sound vectoring channel which is the trough between the extended head and the side of the tablet. This channel directs the sound towards the listeners ears instead of laterally and outward. This in turn augments the apparent volume at the listeners ears.

### DETAILED DESCRIPTION OF THE INVENTION

The device is a plane with a curved tip which is rounded to conform to the edges of the tablet. The device has a pressure sensitive adhesive which allows it to adhere to the electronic tablet. The device is designed so that the curved portion can project outward via a tab inside a grooved track in the center of the plane. When extended, the curved portion vectors sound toward the tablet user.

### Examples of the Invention

In one preferred embodiment, the device is 2 inches squared in dimension and 25 mils thick. The curve begins at 0.25 inches from the tip of the “T” portion which extends perpendicularly to the rest of the planar device. The stem of the track is 1 inch wide. The curved portion extends outward 0.5 inches when deployed for use. The device is made from a thermoplastic such as polyamide or a copolymer such as acetyl butyl styrene.

The material reflects sound and projects it toward the device user. In some preferred embodiments, the thermoplastic has an elastomer backing to facilitate contacts with the surface with the support, as well as better reflect the sound from the speakers.

In another preferred embodiment, the plane is made into a tablet case and deploys from a grove in the case.

In yet another preferred embodiment, the device is magnetically adhered to the case.

In yet another preferred embodiment, the device adheres to the back of the tablet via small clamps.

In yet another preferred embodiment, the device uses suction to adhere to the back of the electronic tablet.

In all preferred embodiments, the curve deploys facing away from the back of the device towards the front, where it redirects sound waves.

In another preferred embodiment, the device has small projections which are either fixed or deployable using a living hinge, facing the back of the tablet. In this preferred embodiment the projections serve as contact points with the substrate so that the tablet can be supported at an angle. This allows the user to visualize the screen at an angle which lifts the screen towards the viewer.

In another preferred embodiment the device is simply a card shaped rectangular device 2 inches by 2 inches by 35 mils which is curved at the end and can be attached and detached from the device by the use of an adhering mechanism such as a pressure sensitive adhesive.

In yet another preferred embodiment the device is simply a card shaped rectangular device 2 inches by 2 inches by 35 mils which is curved at the end and can be attached and detached from the device by the use of an adhering mechanism such as a clamp system.

In another preferred embodiment the device is simply a card shaped rectangular device 2 inches by 2 inches by 15 mils which is curved at the end and can be attached and detached from the device by inserting it into a slot in the back of the tablet computer device which received the non curved extremity of the device. When the device is not in use, it is simply pulled out and stored separately from the tablet.

1. The claim in which a plane with a curved end which projects away from the plane at an angle of 30 degrees to 90 degrees and redirects sound towards an electronic tablet computer user from the side speakers.

2. The claim in 1 in which a plane with a curved end is attached to an electronic tablet device at the level of the lateral speakers and placed behind them creating a deployable rectangular trough which directs sound toward the electronic tablet computer device user.

3. The claims in 1 and 2 where the deployable portion of the device is held in place on a groved track which allows the curved portion to extend and retract to and from the edges of the device where the speakers are located.

4. The claims in 1 and 2 where the deployable portion of the device is held in place on a interfacing magnetic surfaces which allows the curved portion to extend and retract to and from the edges of the device where the speakers are located.

5. The claims in 1 and 2 where the deployable portion of the device is held in place by clamps which allows the curved portion to extend and retract to and from the edges of the device where the speakers are located.

6. The claims in 1 and 2 where the deployable portion of the device is held in place by pressure sensitive adhesive which allows the curved portion to be extend and retracted to and from the edges of the device where the speakers are located.

7. The claims claims in 1 and 2 where the device is made from a thermoplastic.

8. The claims claims in 1 and 2 where the device is made from thermoset polymer.

9. The claims claims in 1 and 2 where the device is made from a composite material.

10. The claims claims in 1 and 2 where the device is made from a metal.

11. The claims claims in 1 and 2 where the device is made from a nano-composite.

12. The claims claims in 1 and 2 where the device is made from a ceramic.

13. The claims claims in 1 and 2 where the device is made from an elastomer.

14. The claims claims in 1 and 2 where the device is made from wood.

15. The claims claims in 1 and 2 where the device is made from plant fiber.

16. The claims claims in 1 and 2 where the device is made from fabric.
